(19) United States
(12) Patent Application Publication
(10) Pub. No.: US 2009/0135735 A1
(43) Pub. Date: May 28, 2009

(54) Method and apparatus of RTP control protocol (RTCP) processing in real-time transport protocol (RTP) intermediate systems

(75) Inventors: Peng Zhang, Buffalo Grove, IL (US); Rafid A. Sukkar, Aurora, IL (US); Jeffrey A. Hawbaker, Naperville, IL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Operations, Inc., Naperville, IL (US)

(21) Appl. No.: 12/082,021

(22) Filed: Apr. 8, 2008

Related U.S. Application Data
(63) Continuation-in-part of application No. 11/986,983, filed on Nov. 27, 2007.

(51) Int. Cl. H04L 12/56; G06F 11/00

(52) U.S. Cl. 370/253

(57) ABSTRACT

Media processing of real-time protocol (RTP) packets used in time sensitive applications makes efficient use of network resources, e.g., by dropping or resizing the packets, but hinders measuring and reporting end-to-end reception quality. Because media processing causes a difference between what is sent and received, end-to-end reception quality cannot be measured validly without accounting for this difference. Accordingly, a method and corresponding apparatus are provided to track changes to RTP packets of an RTP session caused by media processing, modify RTP packet information of the RTP packets based on the tracked changes, correct RTP control protocol (RTCP) packets corresponding to the RTP session based on the tracked changes, the corrected RTCP packets being a measure of the end-to-end reception quality of the RTP session, and report the end-to-end reception quality of the RTP session by forwarding the corrected RTCP packets. Thus, end-to-end reception quality can be validly measured and reported.

### RELATED APPLICATION

This application is a continuation-in-part of U.S. application Ser. No. 11/986,983, filed Nov. 27, 2007. The entire teachings of the above application are incorporated herein by reference.

### BACKGROUND OF THE INVENTION

The real-time transport protocol (RTP) provides end-to-end network transport functions suitable for applications transmitting real-time data, such as audio, video or simulation data, over multicast or unicast network services. The data transport is augmented by a real-time control protocol (RTCP) to allow monitoring of the data delivery in a manner scalable to large multicast networks and to provide minimal control and identification functionality. RTP and RTCP are designed to be independent of the underlying transport and network layers.

### SUMMARY OF THE INVENTION

An example embodiment of the present invention may be implemented in the form of a method or corresponding apparatus which provides end-to-end reception quality feedback between a sending end system and a receiving end system. The method and corresponding apparatus according to one embodiment of the present invention includes: (i) tracking changes to real time transport protocol (RTP) packets of the RTP session caused by media processing of the RTP packets to produce tracked changes; (ii) modifying RTP packet information of the RTP packets based on the tracked changes; (iii) correcting RTP control protocol (RTCP) packets corresponding to the RTP session based on the tracked changes to produce corrected RTCP packets, the corrected RTCP packets being a measure of the end-to-end reception quality of the RTP session; and (iv) reporting the end-to-end reception quality of the RTP session by forwarding the corrected RTCP packets.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of an example network in which example embodiments of the present invention may be employed;

FIG. 2A is a network diagram of an example network in which packet information is modified in accordance with an example embodiment of the present invention;

FIG. 2B is a packet diagram that illustrates a typical real-time transport protocol (RTP) header and an example modified RTP header modified in accordance with an example embodiment of the present invention;

FIG. 3A is a network diagram of an example network in which report packets are corrected in accordance with example embodiments of the present invention;

FIGS. 3B and 3C are packet diagrams that illustrate typical RTP control protocol (RTCP) packets and example corrected RTCP packets corrected in accordance with example embodiments of the present invention;

FIG. 4 is a flow chart of an example process used to estimate an extended highest sequence number received in accordance with an example embodiment of the present invention;

FIG. 5 is a flow chart of an example process for measuring end-to-end reception quality of an RTP session in accordance with an example embodiment of the present invention;

FIG. 6 is a block diagram of an example apparatus to measure end-to-end reception quality of an RTP session, in accordance with an example embodiment of the present invention;

FIG. 7 is a block diagram of an example correcting unit to correct packets used to measure end-to-end reception quality of an RTP session, in accordance with an example embodiment of the present invention;

FIGS. 8-1 and 8-2 are flow charts providing an overview of an example process for measuring end-to-end reception quality of an RTP session, in accordance with example embodiments of the present invention;

FIG. 9 is a flow chart of an example process for providing a meaning of a sequence number reported in an RTCP receiver report from a receiver, in accordance with an example embodiment of the present invention;

FIG. 10 is a packet diagram that illustrates a typical RTP control protocol (RTCP) receiver report and example corrected RTCP receiver report corrected in accordance with example embodiments of the present invention;

FIG. 11 is a flow chart of an example process for measuring a reception quality of RTP packets sent from a sender, in accordance with an example embodiment of the present invention;

FIG. 12 is a flow chart of an example process for extracting a reception quality of RTP packets sent to a receiver, in accordance with an example embodiment of the present invention; and

FIG. 13 is a block diagram of an example apparatus to measure end-to-end reception quality of an RTP session, in accordance with an example embodiment of the present invention.

### DETAILED DESCRIPTION OF THE INVENTION

A description of example embodiments of the invention follows.

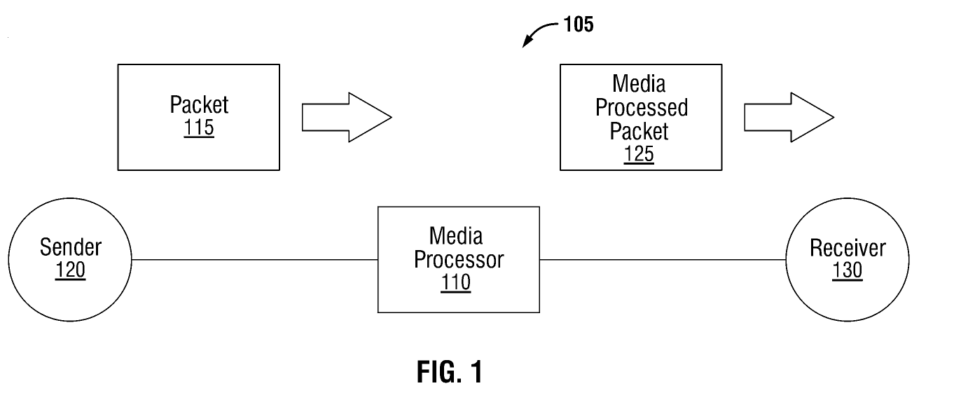

FIG. 1 is an example network 105 that includes a media processor 110 that performs media processing on packets 115 from a sender 120. Resulting media processed packets 125 are received by a receiver 130. Media processing causes changes in packets such that the packets 115 sent by the sender 120 are not the same as the media processed packets 125 received by the receiver 130. These changes include, for example, a change in the number of the packets 115 sent by the sender 120 and the number of the media processed packets 125 received by the receiver 130, and a change in the size of the packets 115 sent by the sender 120 and the size of the media processed packets 125 received by the receiver 130. As an example, media processing of real-time protocol (RTP) packets used in Voice over Internet Protocol (VoIP) and other time sensitive applications makes for efficient use of network resources, e.g., by dropping or changing the size of RTP packets carrying echo as contrasted with voice.

One measure of quality of a network is reception quality. Intuitively, if what was received by a receiver matches what was sent by a sender, then the reception quality of a network is “good.” Conversely, if what was received by a receiver differs from what was sent by a sender, for example, the receiver received fewer packets than were sent by the sender, the reception quality of a network is “poor.” However, in a network, such as the network 105 of FIG. 1, in which packets are media processed such that packets sent by a sender and packets received by a receiver are not the same, simply comparing what was received with what was sent, and no more, produces an invalid measure of reception quality. Differences between what was received and what was sent are not necessarily due to poor reception quality of a network, but rather may be caused at least in part by media processing of packets in the network.

As an example, when a media processor or other RTP intermediate systems changes the RTP packet size of an RTP packet, such as to change an RTP packet carrying an echo into an RTP packet carrying comfort noise, a sender's byte count field in an RTCP sender report does not reflect the changes in packet size. In another example, when an RTP intermediate system changes the number of RTP packets transported, such as to remove an RTP packet carrying an echo as contrasted with carrying a voice, sequence numbers in RTP headers and a sender's packet count field in an RTCP sender report do not reflect changes in packets transported. If reception reports from a receiving end system are forwarded to a sending end system by the RTP intermediate system with the reception report's contents intact, that is unchanged, an inconsistency between the two end systems may cause the reception quality feedback in the reception report to be invalid.

One way to avoid the foregoing problem of reception quality feedback is for an RTP intermediate system to discard all reception reports from a receiving end system. This approach, however, makes no reception quality feedback available.

Another way is for an RTP intermediate system to generate reception reports based on reception by the RTP intermediate system itself. However, this approach is inadequate because the reception quality feedback is only available for either a link between a sending end system and the RTP intermediate system or a link between the RTP intermediate system and a receiving end system, but not between the sending end system and the receiving end system.

In yet another way, one that addresses the aforementioned inadequacies and reflects changes caused by media processing, a reception quality feedback technique may: (1) track changes to packets caused by media processing of the packets; (2) modify packet information of the packets based on the tracked changes; (3) corrects report packets based on the tracked changes; and (4) report the end-to-end reception quality by forwarding the corrected report packets. The corrected packets of this reception quality feedback technique may be considered a valid a measure of end-to-end reception quality.

One of ordinary skill in the art will readily recognize that the foregoing reception quality feedback technique and example embodiments thereof may be employed by an intermediate system, such as the media processor 110. Alternatively, the technique and example embodiments thereof may be employed by another intermediate system separate and distinct from the media processor 110. The particulars of the last technique and example embodiments thereof will now be described.

In TABLE 1, an embodiment tracks changes caused by media processing by updating both a send sequence number (sn_send) 230 and a total packet count of packets sent (tpcps) 235 by a number of packets sent to a receiver after media processing by a media processor.

In a convenient embodiment illustrated by TABLE 1, for a first packet 225a sent after media processing, the embodiment sets the send sequence number 230 to a sequence number of the first packet 225a, i.e., sn_send=sn_first. In some embodiments, it may be advantageous to store the sequence number of the first packet 225a. For each packet sent thereafter, after media processing, the embodiment increments the send sequence number 230 by one, i.e., sn_send=sn_send+1.

For example, for a second packet 225b, the send sequence number 230 is the next sequence number after the send sequence number 230. A third packet 225c, however, is not sent after media processing, but rather is dropped. The embodiment does not increment the send sequence number 230, i.e., sn_send=sn_send.

The above example illustrated in TABLE 1 highlights an important effect or result of media processing. A sequence number for a packet, as is known to the media processor 110 and the sender 120, differs from a sequence number for the packet after media processing, as is known to the media processor 110 and the receiver 130. As such, it may be said that there are two “streams” of sequence numbers: one stream for packets between the processor 110 and the sender 120 and another stream for packets between the media processor 110 and the receiver 130. There being two streams of sequence numbers has significant implications when measuring and reporting reception quality, as will be described later. In the interim, because media processing results in there being two streams of sequence numbers, sequence numbers for packets before media processing and sequence numbers for packets after media processing are not the same, but are rather corresponding.

In another convenient embodiment also illustrated by TABLE 1, for the first packet 225a, the embodiment sets a total packet count of packets (tpcps) 235 to one. For each packet sent thereafter, after media processing, the embodiment increments the total packet count of packets sent 235 by one, i.e., tpcps=tpcps+1.

For example, after sending the first packet 225a, sending the second packet 225b increases the total packet count of packets sent 235 by one. The third packet 225c, however, is not sent after media processing, but rather is dropped. The embodiment does not increment the total packet count of packets sent 235, i.e., tpcps=tpcps.

Additionally, the embodiment tracks changes caused by media processing by updating a total octet count of packets sent (tocps) 240 by a number of octets sent to a receiver after media processing by a media processor. For the first packet 225a, the embodiment sets the total octet count of packets sent 240 to the octet count of the first packet 225a. For each packet sent thereafter, after media processing, the embodiment increments the total octet count of packets sent 240 by the octet count of the respective sent packet, i.e., tocps=tocps+octet count of packet sent.

For example, after sending the first packet 225a, sending the second packet 225b increases the total octet count of packets sent 240 by the octet count of the second packet 225b. The third packet 225c, however, is not sent after media processing, but rather is dropped. The embodiment does not increment the total octet count of packets sent 240, i.e., tocps=tocps.

As described above, the embodiment reflects changes to packets caused by media processing, such as changes in a number and a size of packets sent to a receiver, by updating a send sequence number (sn_send), a total packet count of packets sent (tpcps), and a total octet count of packets sent (tocps). Subsequently, these updated values may be further used by the embodiment to modify packet information and to correct packets that are a measure of reception quality. In this way, the embodiment modifies packet information and corrects packets based on the changes caused by media processing.

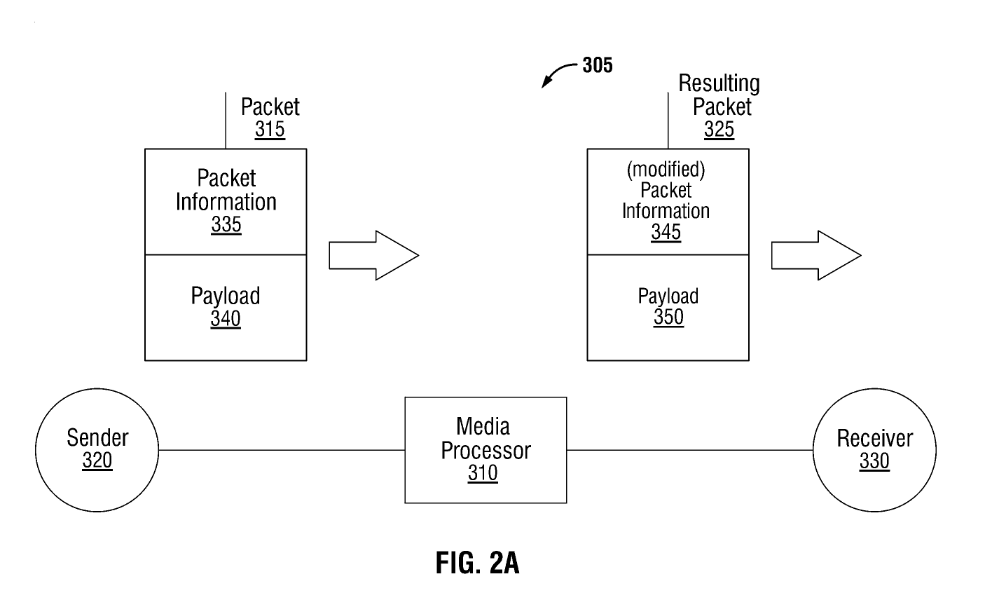

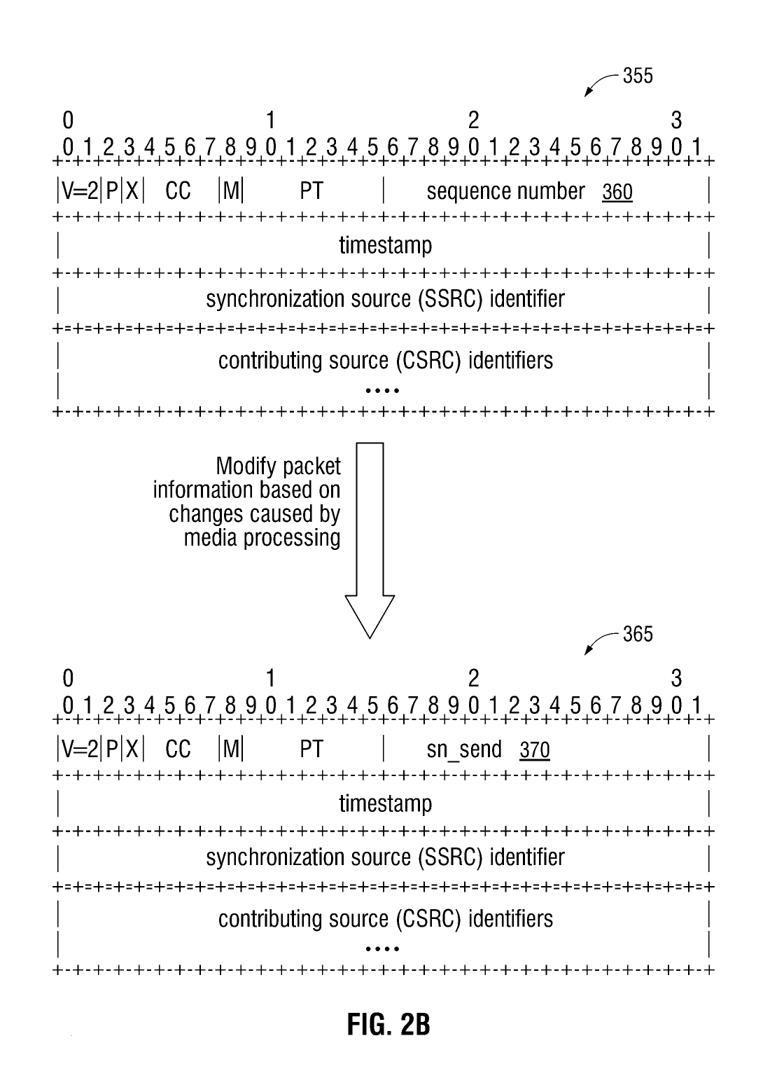

FIG. 2A, is an example network 305 in which a media processor 310 media processes packets 315 from a sender 320. Resulting media processed packets 325 are received by a receiver 330. Each of the packets 315 sent from the sender 320 has a packet information portion (i.e. overhead) 335 and a payload portion 340. An embodiment modifies the packet information portion 335 based on changes caused by media processing. In each of the resulting media processed packets 325 sent to the receiver 330, a modified packet information portion 345 reflects the changes caused by media processing.

Depending on the changes caused by media processing, the payload portion 340 of the packet 315 sent from the sender 320 and a payload portion 350 of the media processed packet 325 sent to the receiver 330 after media processing may be different. For example, media processing causes the size of a packet to change. In such an example, a payload portion of a packet sent from a sender differs from the payload portion after media processing.

FIG. 2B is a packet diagram that illustrates packet information, which may be a real-time transport protocol (RTP) header 355. The embodiment modifies the RTP header 355 by replacing a sequence number 360. In a modified RTP header 365, a sequence number of a packet sent after media processing (sn_send) 370 replaces the sequence number 360. As described above in reference to TABLE 1, the sequence number of the packet sent after media processing 370 reflects changes caused by media processing, namely, a change in the number of packets sent to a receiver after media processing. Consequently, an RTP packet sent to a receiver after media processing has the modified RTP header 365 and not the RTP header 355.

While a receiver's understanding of what was received reflects changes caused by media processing, this understanding differs or is otherwise inconsistent with a sender's understanding of what was sent. Without correcting this inconsistency in understanding, a measure of end-to-end reception quality of a network in which packets are media processed and changed cannot be valid.

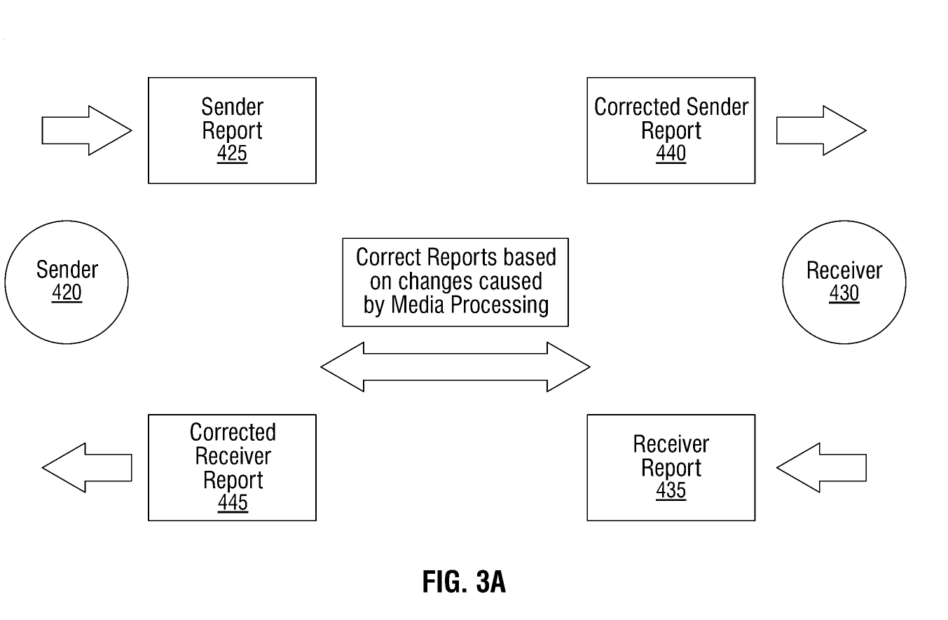

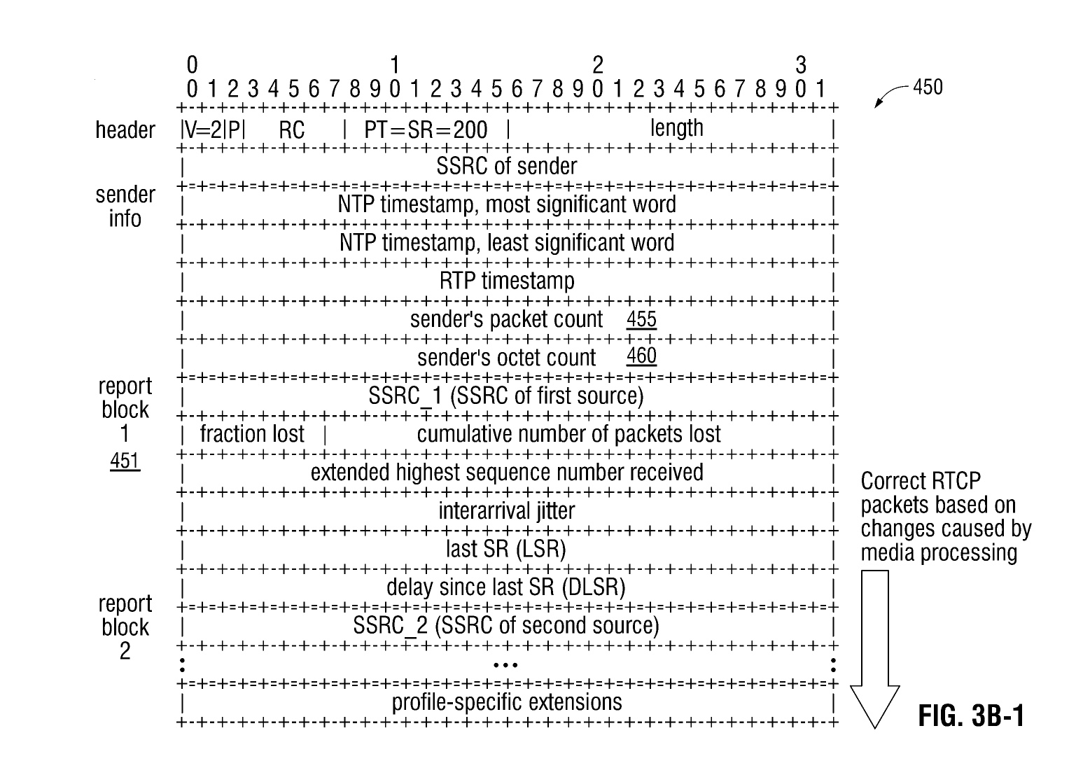

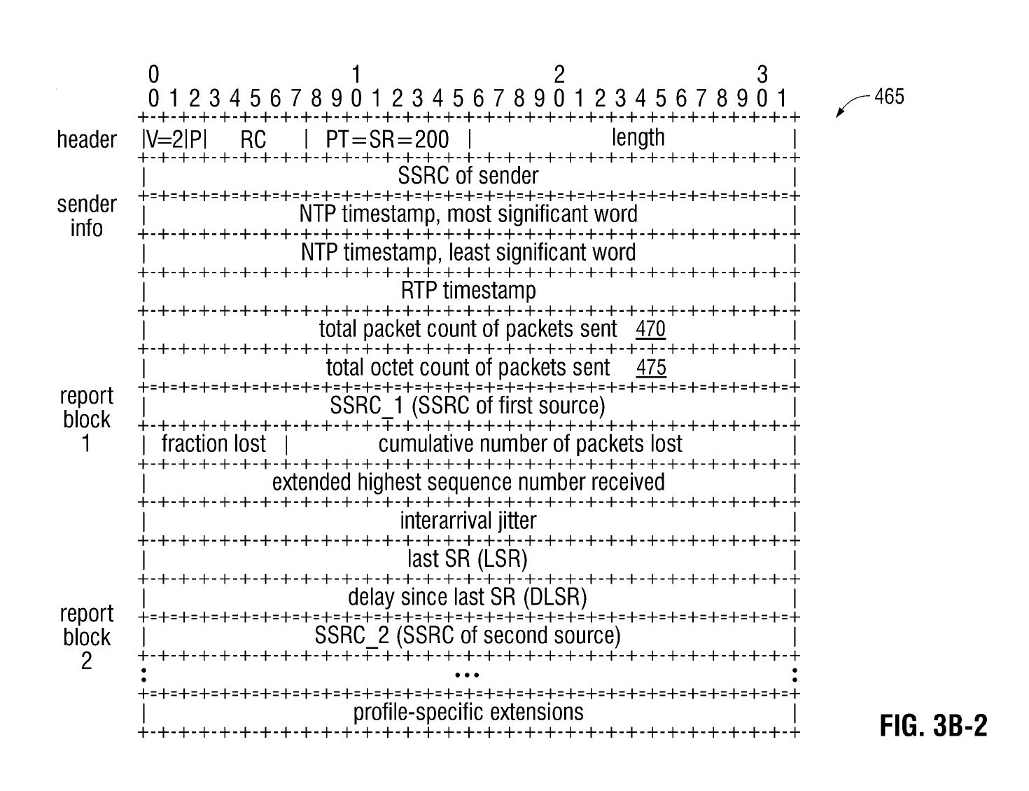

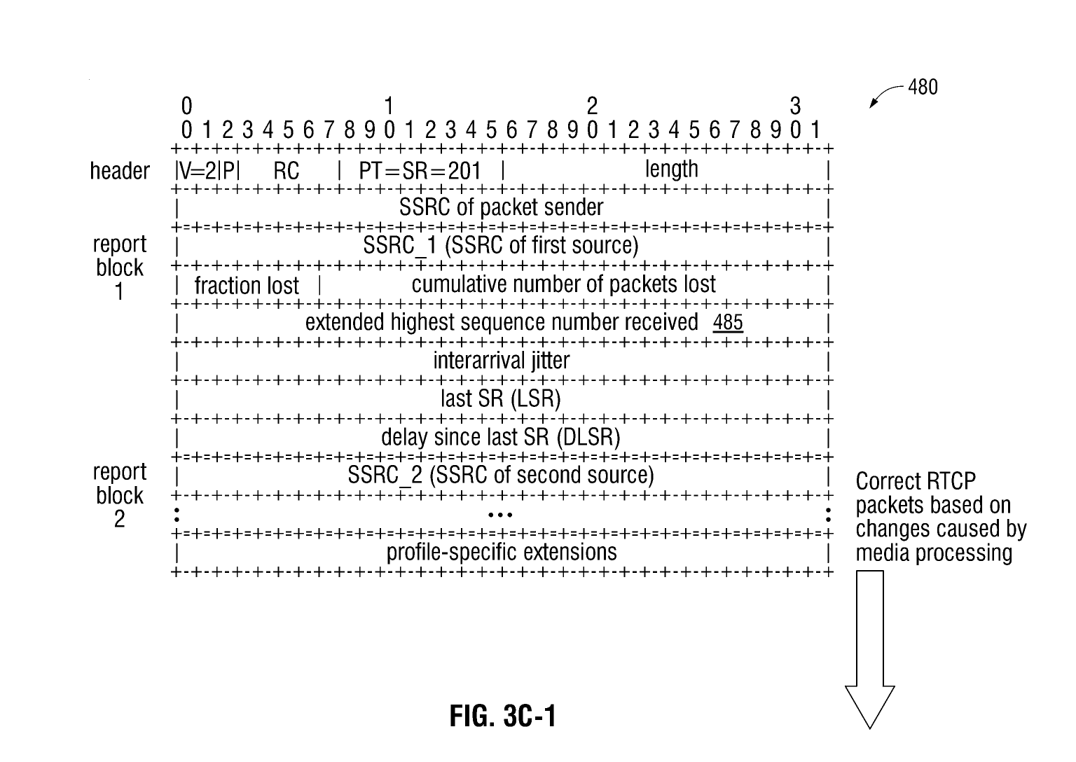

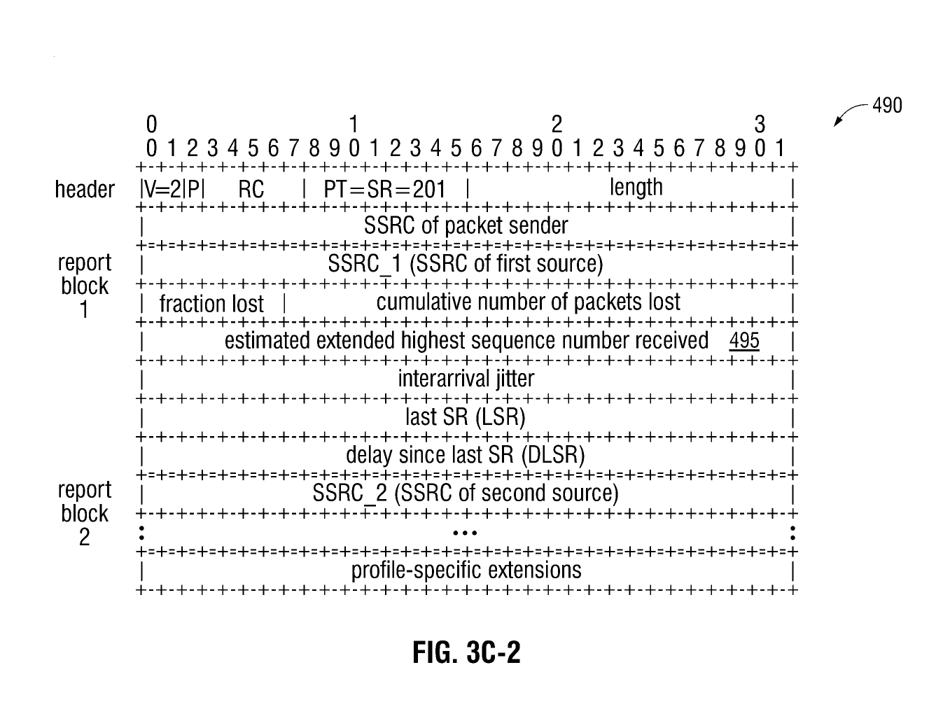

FIG. 3A is a data flow diagram that illustrates a sender's 420 understanding that what was sent is embodied or otherwise described in a sender report 425. Similarly, a receiver's 430 understanding of what was received is described in a receiver report 435. The sender 420 and the receiver 430 exchange the sender report 425 and the receiver report 435, respectively, to measure reception quality of the network. If the sender report 425 and the receiver report 435 “match,” that is, the sender's 420 understanding of what was sent agrees with the receiver's 430 understanding of what was received (and vice versa), then the measure of reception quality may be deemed “good.” Conversely, if the sender report 425 and the receiver report 435 do not match, or rather the sender 420 disagrees with the receiver 430 regarding what was sent (and vice versa), then the measure of reception quality may be deemed “bad.”

In a network in which packets are media processed and thus changed, a sender's understanding of what was sent and a receiver's understanding of what was received are different. Because this difference is not due to reception quality, or lack of, necessarily, a measure reception quality based on a sender report, such as the sender report 425, and a receiver report, such as the received report 435, is not entirely valid.

The embodiment corrects the sender's 420 understanding of what was sent by correcting the sender report 425. A resulting corrected sender report 440 reflects changes caused by media processing. As such, a measure of reception quality based on the corrected sender report 440 is valid. A difference between the corrected sender report 440 and the receiver's 430 understanding of what was received stems from reception quality and not from changes caused by media processing.

In a similar manner, the embodiment corrects the receiver's 430 understanding of what was received by correcting the receiver report 435. A resulting corrected receiver report 445 reflects changes caused by media processing. As such, a measure of reception quality based on the corrected receiver report 445 is valid. A difference between the corrected receiver report 445 and the sender's 420 understanding of what was sent is due to reception quality and not changes caused by media processing.

FIG. 3B is a packet diagram that illustrates a sender report, which may be an RTP control protocol (RTCP) sender report 450. The embodiment corrects the RTCP sender report 450 by replacing a sender's packet count 455 and a sender's octet count 460. The sender's packet count 455 is a total number of packets sent by a sender since starting transmission up until the RTCP sender report 450 is generated. The sender's octet count 460 is a total number of payload octets (i.e., not including header or padding) sent by the sender since starting transmission up until the RTCP sender report 450 is generated.

In a corrected RTCP sender report 465, a total packet count of packets sent to a receiver (tpcps) 470 and a total octet count of packets sent to a receiver (tocps) 475 replaces the sender's packet count 455 and the sender's octet count 460, respectively. It should be appreciated that the total number of packets sent by a sender (sender's packet count 455) and a total number of packets sent to a receiver (tpcps 470) are not necessarily the same because of media processing of packets. For the same reason, it should also be appreciated that the total number of octets sent by a sender (sender's octet count 460) and a total octet count of packets sent to a receiver (tocps) 475 are also not necessarily the same.

As described in reference to TABLE 1, the total packet count of packets sent 470 reflect changes caused by media processing, namely, a change in a number of packets sent to a receiver after media processing. The total octet count of packets sent 475 reflects a change in the size of packets sent to a receiver after media processing. As such, the corrected RTCP sender report 465 corrects an inconsistency caused by media processing between a sender's understanding of what was sent from the sender and what was sent to a receiver. Having considered or otherwise accounted for changes caused by media processing with the corrected RTCP sender report 465, a difference between a sender's understanding and what was sent to a receiver is not the result of media processing, but is rather a valid measure of reception quality.

FIG. 3C is a packet diagram that illustrates a receiver report, which may be an RTP control protocol (RTCP) receiver report 480. The embodiment corrects the RTCP receiver report 480 by replacing an extended highest sequence number received (ehsnr) 485. The extended highest sequence number received 485 contains the highest sequence number received in an RTP data packet from a sender.

In a corrected RTCP receiver report 490, an estimated extended highest sequence number received (est_ehsnr) 495 replaces the extended highest sequence number received 485. Because RTP packets may be discarded as a result of media processing, resulting in packet information of packets sent to a receiver being modified with updated sequence numbers, as described in reference to TABLE 1 and FIG. 2, a sequence number carried in the extended highest sequence number received 485 in the RTCP receiver report 480 loses its meaning to a sender. To provide meaning, the embodiment estimates the extended highest sequence number received in a process, as described below.

It should be appreciated that the highest sequence number of a packet sent to a receiver and thus received by the receiver (ehsnr 485) and the highest sequence number of a packet sent from a sender are not the same necessarily because of media processing.

As such, the corrected RTCP receiver report 490 corrects an inconsistency caused by media processing between what was sent from a sender and a receiver's understanding of what was sent to the receiver. Having considered or otherwise accounted for changes caused by media processing with the corrected RTCP receiver report 490, a difference between what was sent from a sender and a receiver's understanding is not the result of media processing, but is rather a valid measure of reception quality.

While described within the context of the RTCP receiver report 480, one of ordinary skill in the art will recognize that the foregoing embodiment also applies to the RTCP sender report illustrated in FIG. 3B. Because an RTP session is typically duplex, i.e., a sender is also a receiver, and vice versa, the embodiment may also correct the RTCP sender report 450 by replacing an extended highest sequence number received reported in a report block (e.g., a report block 451 of FIG. 3B). In this case, the extended highest sequence number received contains the highest sequence number received in an RTP data packet from a receiver in a duplex RTP session.

As alluded to in the above description, estimating an extended highest sequence number received provides meaning to a case in which RTP packets are discarded as a result of media processing resulting in packet information of packets sent to a receiver being modified with updated sequence numbers. However, because of media processing, an extended highest sequence number received cannot be estimated from a sequence number. Instead, the extended highest sequence number received is estimated by calculating a time when a last RTP packet sent from a sender was received (ts_lrtp) according to the following:

delay_{—}rt=ts_{—}rr—ts_{—}sr−DLSR; and (1)

ts_{—}lrtp=ts_{—}rr—delay_{—}rt—delay_{—}mp (2)

where,

ts_rr denotes a timestamp from an RTCP receiver report record representing when the RTCP receiver report was received;

ts_sr denotes a timestamp from an RTCP sender report record representing when the RTCP sender report having the same synchronization source as the RTCP receiver report was received;

delay_mp denotes a mean delay caused by media processing; and

DLSR denotes a delay between receiving the last RTCP sender report and the sending an RTCP packet, e.g., a delay between a time a receiver receiving an RTCP sender report and the receiver sending an RTCP receiver report.

It is useful to note that the ts_rr and ts_sr denoting when the RTCP receiver report and the RTCP sender report were received, respectively, are not the same as a network time protocol (NTP) timestamp of an RTCP packet. The network time protocol (NTP) timestamp represents when the RTCP packet was sent, e.g., from a sender (i.e., an RTCP sender report) or from a receiver (i.e., an RTCP receiver report).

The estimated extended highest sequence number received is a sequence number of an RTP record received at the calculated time ts_lrtp. In this way, it may be said that the extended highest sequence number received is estimated from time measurements, namely, (i) a time when the RTCP receiver report was received (ts_rr), (ii) a time when the RTCP sender report was received (ts_sr), (iii) the mean delay caused by media processing; and (iv) the delay between receiving the last RTCP sender report and the sending an RTCP packet (e.g., the RTCP receiver report or the RTCP sender report).

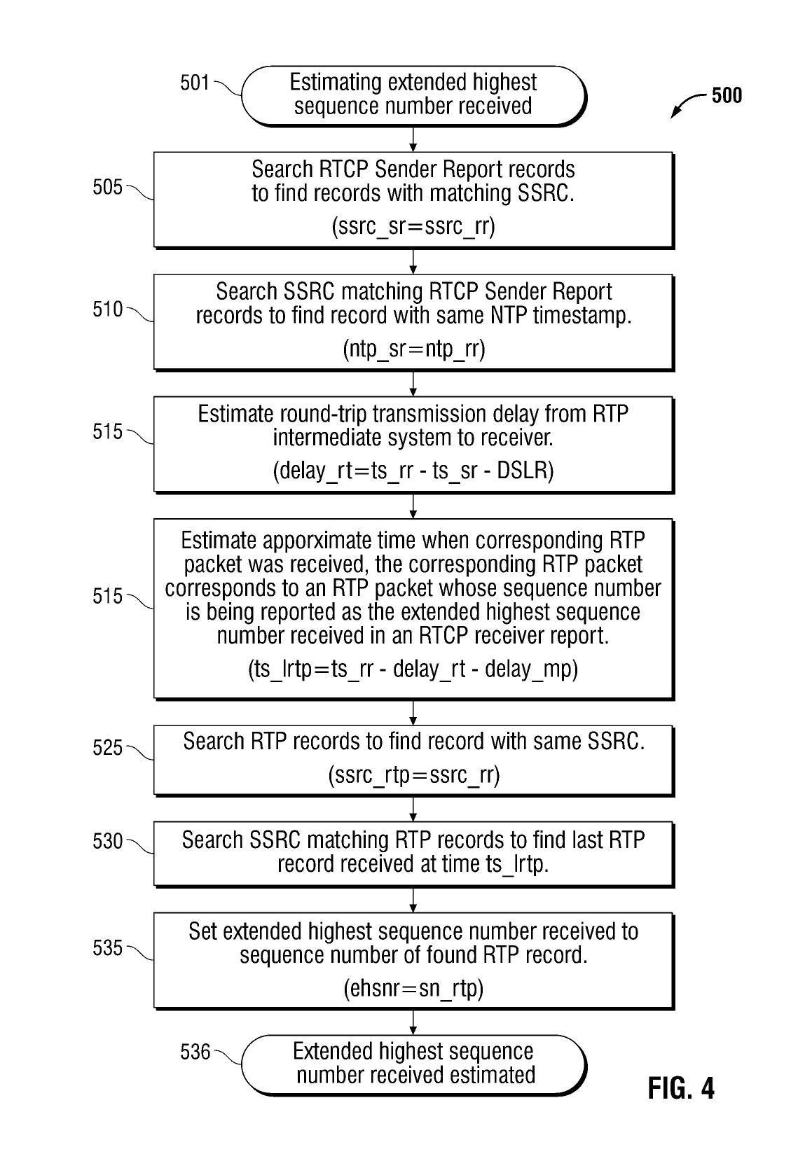

FIG. 4 is a flow diagram that illustrates an example process 500 to estimate an extended highest sequence number received for correcting an RTCP packet. For purposes of illustration, the RTCP packet being corrected is an RTCP receiver report sent from a receiver and received by an RTP intermediate system. It should be readily apparent that the process 500 also applies to estimating an extended highest sequence number received for correcting an RTCP sender report sent from a sender and received by the RTP intermediate system.

The process 500 starts (501). The process 500 searches (505) RTCP sender report records to find those RTCP sender report records with the same synchronization source (SSRC) as a subject RTCP receiver report record which is to be corrected, i.e., ssrc_sr=ssrc_rr. In this way, RTCP packets of interest are limited to those packets belonging to the same RTP session or call.

The process 500 searches (510) the SSRC matching RTCP sender report records to find a subject RTCP sender report record with the same network time protocol (NTP) timestamp (ntp_sr) as the subject RTCP receiver report record (ntp_rr), i.e., ntp_sr=ntp_rr. This further limits the RTCP packets of interest found by the process 500 at (505) to just the subject RTCP packet sender report. As such, the NTP timestamp serves as a unique identifier identifying the subject RTCP packet receiver report and sender report.

The process 500 estimates (515) a round-trip transmission delay to and from a receiver (delay_rt) and the RTP intermediate system from the following time measurements: (i) a time when the RTP intermediate system received the subject RTCP receiver report (ts_rr), (ii) a time when the RTP intermediate system received the RTCP sender report record (ts_sr) (as found by the process 500 at (505)), and (iii) a delay between the receiver receiving the last RTCP sender report and the receiver sending the subject RTCP receiver report (DSLR), i.e., delay_rt=ts_rr−ts_sr−DSLR.

Because of media processing, the highest sequence number of RTP packets received by a receiving end-system (e.g., the receiver) up to a time when an RTCP packet (e.g., the RTCP receiver report) is generated, as reported in the RTCP packet as an extended highest sequence number received, has no significance or meaning to a transmitting end-system (e.g., the sender). Recall, however, RTP packets after media processing correspond to RTP packets before media processing. Accordingly, there may be an RTP packet corresponding (i.e., a corresponding RTP packet) to the RTP packet whose sequence number is reported as the extended highest sequence number in the RTCP packet. The sequence number of the corresponding RTP packet, unlike the highest sequence number reported in the RTCP packet, does have meaning to the transmitting end-system. Accordingly, the RTCP packet may be corrected (to account for media processing) by finding the sequence number of the corresponding RTP packet.

Continuing to refer to FIG. 4, to find a corresponding RTP packet and thus the sequence number of the corresponding RTP packet, the process 500 estimates (520) an approximate time (ts_lrtp) when the corresponding RTP packet was received by the RTP intermediate system from the following time measurements: (i) the time when the RTP intermediate system received the RTCP receiver report (ts_rr); (ii) the round-trip transmission delay to and from a receiver (delay_rt) and the RTP intermediate system as estimated (515) above; and (iii) an estimate of mean delay for media processing (delay_mp), i.e., ts_lrtp=ts_rr−delay_rt−delay_mp.

The process 500 continues and searches (525) RTP records to find those RTP records (ssrc_rtp) with the same SSRC as the subject RTCP receiver report (ssrc_rr), i.e., ssrc_rtp=ssrc_rr.

The process 500 searches (530) the SSRC matching RTP records to find the last RTP record received at the time ts_lrtp. The process 500 sets an extended highest sequence number received (ehsnr) to the sequence number of the found RTP record (sn_rtp), i.e., ehsnr=sn_rtp.

The process 500 ends (536) with the extended highest sequence number estimated.

In a convenient embodiment, in an event an RTP packet is received by an RTP intermediate system, the process 500 stores (not shown) the following information: a synchronization source identifier identifying a source of the RTP packet (ssrc_rtp), a sequence number of the RTP packet (sn_rtp), and a timestamp representing when the RTP packet was received (ts_rtp). In an event an RTCP sender report is received, the process 500 stores (not shown) the following information: a synchronization source identifier identifying a source of the RTCP sender report (ssrc_sr), an NTP timestamp of the RTCP sender report (ntp_sr) representing when the RTCP sender report was sent, and a timestamp from the RTCP sender report record (ts_sr) representing when the RTCP sender report was received. In an event an RTCP receiver report is received, the process 500 stores (not shown) the following information: a synchronization source identifier identifying a source of the RTCP receiver report (ssrc_rr), a last sender report timestamp (LSR) representing when the last RTCP sender report was received, and a timestamp (ts_rr) representing when the RTCP receiver report was received.

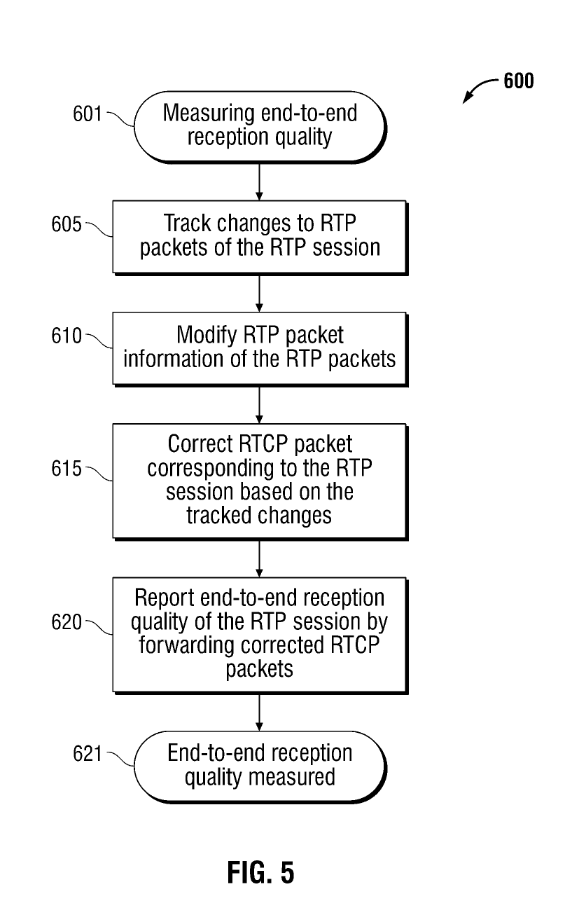

FIG. 5 is a flow diagram of a process 600 that starts (601) measuring end-to-end reception quality of an RTP session. The process 600 tracks (605) changes to RTP packets of the RTP session to produce tracked changes. The tracked changes are caused by media processing of the RTP packets. The process 600 modifies (610) RTP packet information of the RTP packets based on the tracked changes. The process 600 corrects (615) RTCP packets corresponding to the RTP session based on the tracked changes to produce corrected RTCP packets reports. The corrected RTCP packets are a measure of the end-to-end reception quality of the RTP session. The process 600 reports (620) the end-to-end reception quality of the RTP session by forwarding the corrected RTCP packets. The process 600 ends (621) with end-to-end reception quality of the RTP session measured.

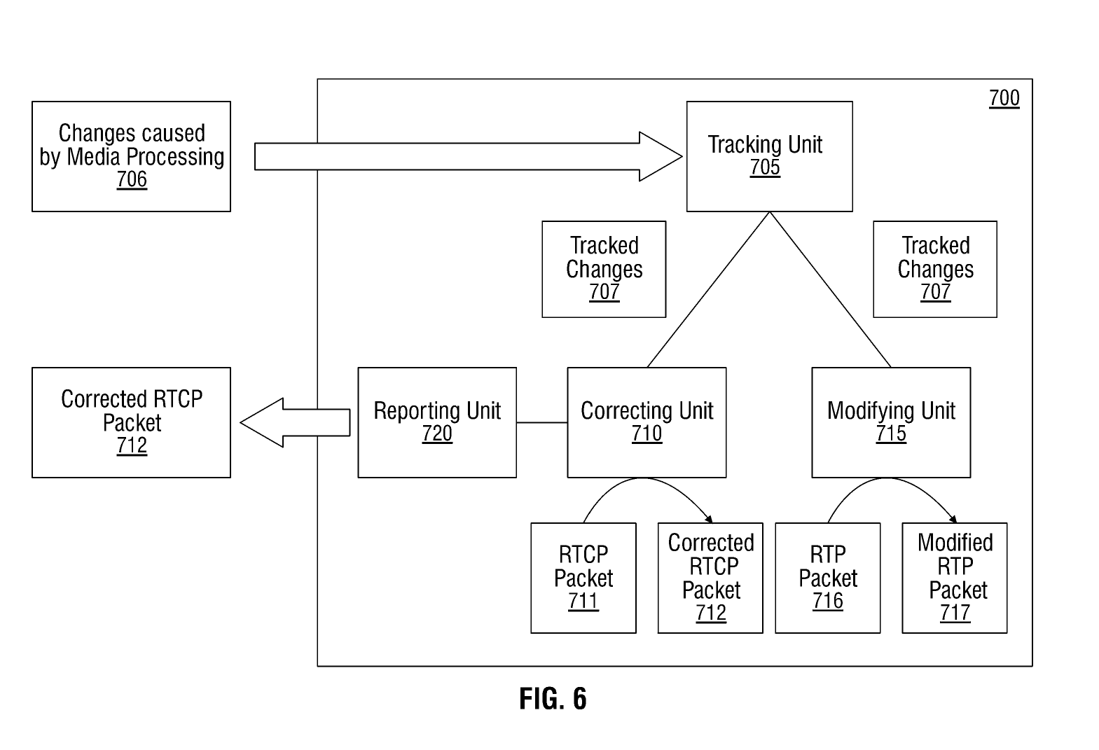

FIG. 6 is a block diagram of an example apparatus 700 to measure end-to-end reception quality of an RTP session that has a tracking unit 705, a correcting unit 710 in communication with the tracking unit 705, a modifying unit 715 also in communication with the tracking unit 705, and a reporting unit 720 in communication with the correcting unit 710. The tracking unit 705 tracks changes 706 caused by media processing (in accordance with example embodiments described above) to produce tracked changes 707. One of ordinary skill in the art will readily recognize that the apparatus 700 may be supplied with the changes 706, for example, from a media processor (not shown). Alternatively, the apparatus 700 may itself determine the change 706 caused by media processing. As such, the apparatus 700 may or may not perform media processing itself.

Based on the tracked changes 707, the correcting unit 710 corrects (denoted by an arc with an arrowhead) an RTCP packet 711 resulting in a corrected RTCP packet 712, in accordance with example embodiments described. Also based on the tracked changes 707, the modifying unit 715 modifies (denoted by an arc with an arrowhead) an RTP packet 716, resulting in a modified RTP packet 717, in accordance with example embodiments described above. The reporting unit reports the end-to-end reception quality of the RTP session by forwarding the corrected RTCP packet 712.

In a convenient embodiment, the example apparatus 700 has an interface (not shown) to interface the apparatus 700 to an RTP network (not shown). The interface is in communication with the correcting unit 710 to receive the RTCP packet 711 from the RTP network and is in communication with the reporting unit 720 to forward the corrected RTCP packet 712 to the RTP network and thus report end-to-end reception quality. The interface is also in communication with the modifying unit 715 to receive the RTP packet 716 from the RTP network and to transmit the modified RTP packet 717 to the RTP network.

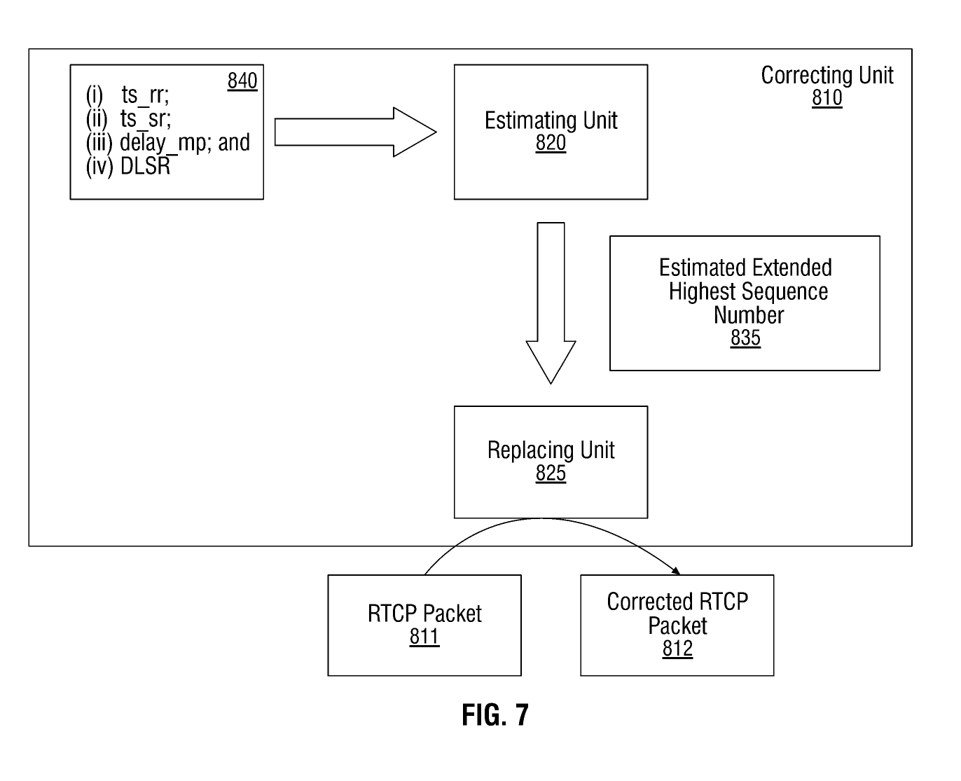

FIG. 7 is a block diagram of an example correcting unit 810 to correct an RTCP packet 811 (e.g., an RTCP sender report and RTCP receiver report) and to produce a corrected RTCP packet 812. The correcting unit 810 includes a replacing unit 825 and an estimating unit 830. The replacing unit 825 replaces, in an RTCP sender report (viz., the RTCP packet 811), a first total packet count and octet count of packets sent from a sender with a second total packet count and octet count of packets sent to a receiver, which is based on the tracked changes to produce a corrected RTCP sender report (viz., the corrected RTCP packet 812). The corrected RTCP sender report is a measure of the end-to-end reception quality of the RTP session. Additionally, the replacing unit 825 replaces, in an RTCP receiver report (viz., the RTCP packet 811), an extended highest sequence number received with an estimated extended highest sequence number received (estimated by the estimating unit 830 described below), the corrected RTCP receiver report being a measure of the end-to-end reception quality of the RTP session.

The estimating unit 830 estimates an extended highest sequence number 835, in accordance with example embodiments described above. The estimating unit 830 estimates the extended highest sequence number 835 from input 840. The input 840 includes: a time when an RTP intermediate system received the RTCP receiver report (ts_rr); (ii) a time when the RTP intermediate system received the RTCP sender report (ts_sr); (iii) an estimate of mean delay for media processing (delay_mp); and (iv) a delay between a receiver receiving the last RTCP sender report and the receiver sending the RTCP receiver report (DSLR).

In a convenient embodiment, the correcting unit 810 also includes a storing unit (not shown) to store: (i) in an RTP record, in an event an RTP packet is received, a synchronization identifier source identifying a source of the RTP packet (ssrc_rtp), a sequence number of the RTP packet (sn_rtp), and a timestamp representing when the RTP packet was received (ts_rtp); (ii) in an RTCP sender report record, in an event an RTCP sender report is received, a synchronization source identifying a source of the RTCP sender report (ssrc_sr), an NTP timestamp of the RTCP sender report (ntp_sr) representing when the RTCP sender report was sent, and a timestamp (ts_sr) representing when the RTCP sender report was received; and (iii) in an RTCP receiver report record, in an event an RTCP receiver report is received, a synchronization source identifying a source of the RTCP receiver report (ssrc_rr), a last sender report timestamp (LSR) representing when the last RTCP sender report was received, and a timestamp (ts_rr) representing when the RTCP receiver report was received.

The foregoing embodiments describe correcting an RTCP receiver report by replacing an extended highest sequence number received with an estimated extended highest sequence number received. The estimated extended highest sequence number received is estimated based on a time a last RTP packet sent from a sender was received. As such, it may be said that an RTP packet is the basis for correcting an RTCP receiver report.

In another correcting technique, the basis for correcting an RTCP receiver report is an RTCP sender report. An RTCP sender report from a sender, reporting what was sent (e.g., the sender's packet count 455 and the sender's octet count 460 of FIG. 3B), causes a receiver to respond and report in an RTCP receiver report what was received. As such, it may be said that the RTCP sender report corresponds to the RTCP receiver report (hereinafter, referred to as a corresponding sender report).

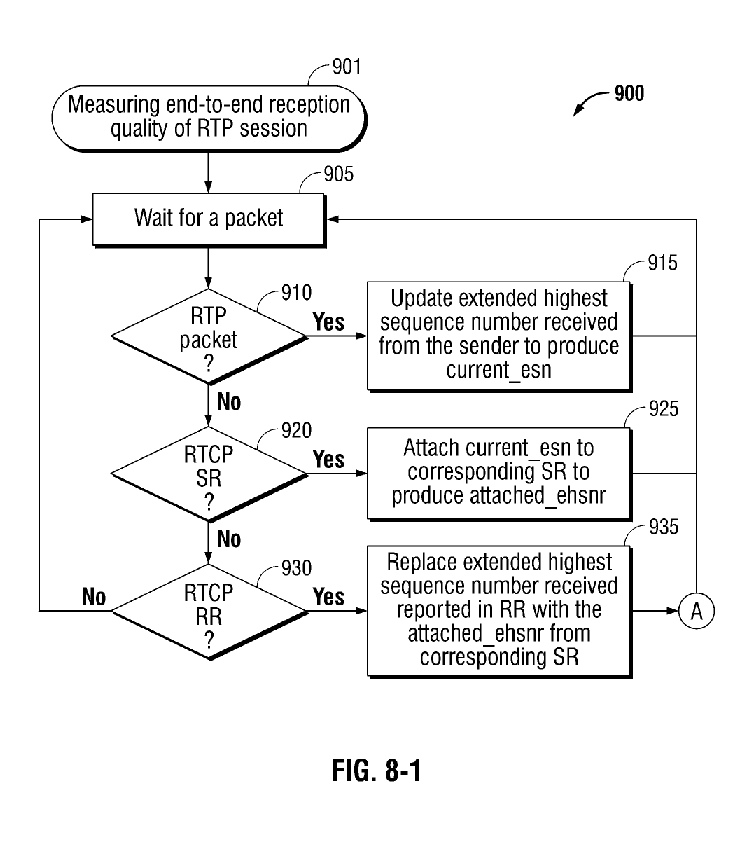

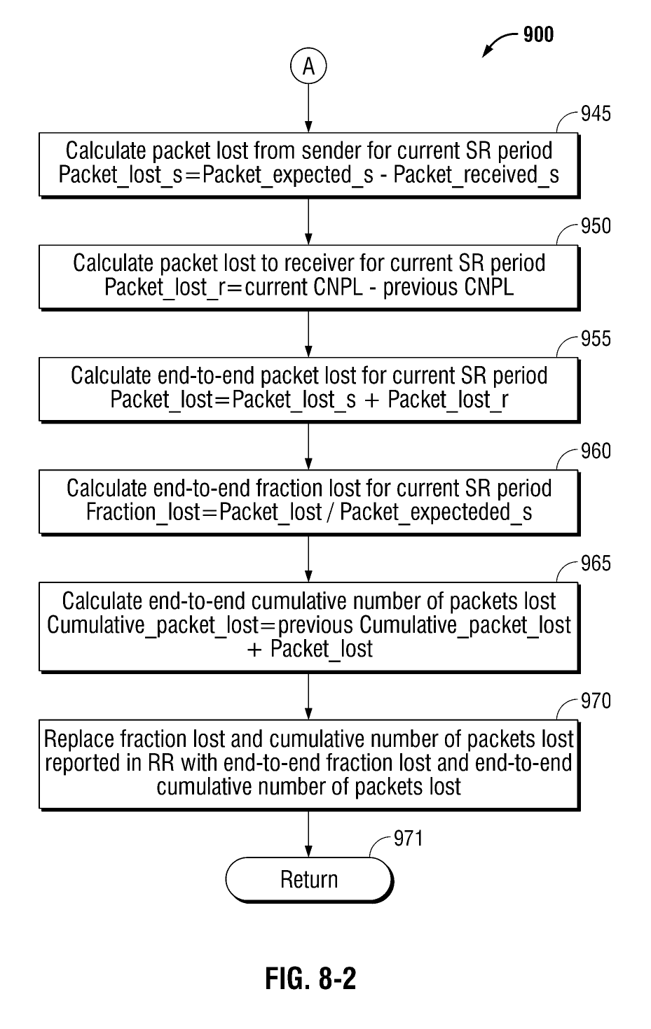

FIGS. 8-1 and 8-2 are flowcharts which together provide an illustrated overview of an example process 900 for measuring end-to-end reception quality of a real-time transport protocol (RTP) session. As an overview the process 900 begins (901) and waits (905) for a packet. The process 900 determines (910) whether the packet received is an RTP packet. If the process 900 determines (910) the packet received is an RTP packet, the process 900 updates (915) an extended highest sequence number received from a sender to produce a current extended sequence number (current_esn).

However, if the process 900 determines (910) the packet received is not an RTP packet, the process 900 then determines (920) whether the packet received is an RTCP sender report (SR).

If the process 900 determines (920) the received packet is an RTCP sender report, referred to as a corresponding sender report, the process 900 attaches (925) the current_esn to the corresponding sender report to produce an attached extended highest sequence number received (attached_ehsnr).

However, if the process 900 determines (920) the packet received is not an RTCP sender report, the process 900 then determines (930) whether the packet received is an RTCP receiver report (RR).

If the process 900 determines (930) the packet received is not an RTCP receiver report, the process 900 returns and waits (905) for another packet However, if the process 900 determines (930) the packet received is an RTCP receiver report, the process 900 then replaces (935) an extended highest sequence number received reported in the RTCP receiver report with the attached_ehsnr from the corresponding sender report (as attached above at 925) to produce a corrected RTCP receiver report. The corrected RTCP receiver report is a measure of the end-to-end reception quality of the RTP session.

Additionally, if the process 900 determines (930) the packet received is an RTCP receiver report, the process 900 calculates (945) a packet loss from the sender for a current sender report period or duration. The process 900 further calculates (950) a packet loss to the receiver for the current sender report period or duration. The process 900 then calculates (955) an end-to-end packet loss for the current sender report period or duration from the packet loss to the sender and the packet loss to the receiver (as calculated above at 945 and 950, respectively).

The process 900 also calculates (960) an end-to-end fraction lost for the current sender report period or duration. The process 900 further calculates (965) an end-to-end cumulative number of packets lost.

The process 900 replaces (970) a fraction lost and a cumulative number of packets lost reported in the RTCP receiver report with the end-to-end fraction lost and the end-to-end cumulative number of packets lost (as calculated above at 960 and 965, respectively) to produce a corrected RTCP receiver report. The corrected RTCP receiver report is a measure of the end-to-end reception quality of the RTP session.

The process 900 then returns (971) and waits (905) for another packet.

Typically, an extended highest sequence number received reported in an RTCP receiver report (e.g., the extended highest sequence number received 485 of FIG. 3C) is a time reference point providing a context in which to measure reception quality of RTP packets sent from the sender to the receiver. As such, it may be said that the extended highest sequence number received reported in the RTCP receiver report is a component making up a measure reception quality of RTP packets sent from the sender to the receiver.

However, because of media processing or other such processes resulting in two streams of sequence numbers (one stream of sequence summers for RTP packets sent from the sender prior to processing and another stream of sequence summers for RTP packets sent to the receiver after processing), the highest sequence number of an RTP packet sent to a receiver (and thus received by the receiver) and the highest sequence number of an RTP packet sent from the sender are not necessarily the same. As such, it may be said that a sequence number reported in an RTCP receiver report from a receiver as the extended highest sequence number received loses its meaning to a sender.

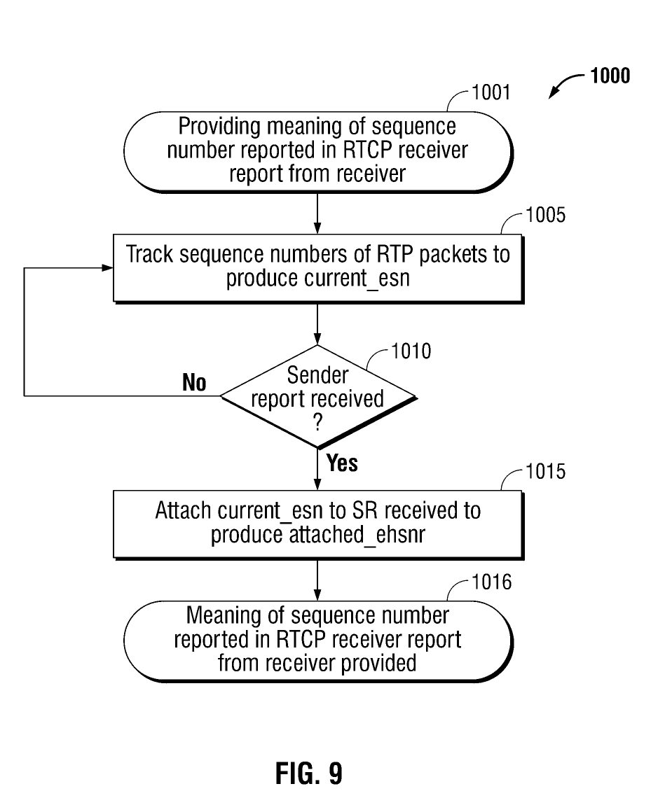

FIG. 9 is a flow chart that illustrates an example process 1000 to provide a meaning of a sequence number reported in an RTCP receiver report from a receiver. The process 1000 starts (1001). The process 1000 tracks (1005) sequence numbers of RTP packets sent from a sender to produce a current extended sequence number. It should be appreciated that the sequence numbers may be extended or otherwise calculated with a corresponding count of sequence number cycles to account for recycling of the sequence numbers. The process 1000, in an event an RTCP sender report is received (1010), attaches (1015) the current extended sequence number to the RTCP sender report received to produce an attached extended highest sequence number received. In this way, the attached extended highest sequence number received represents an RTP packet sent from the sender prior to the sender sending the RTCP sender report. The process 1000 ends (1016) with the meaning of the sequence number reported in the RTCP receiver report from the receiver provided.

Having provided a meaning, an attached extended highest sequence number received attached to an RTCP sender report which corresponds to an RTCP receiver report, corrects the RTCP receiver report and produces a corrected RTCP receiver report. The corrected RTCP receiver report corrects an inconsistency caused by media processing between what was sent from a sender and a receiver's understanding of what was sent to the receiver. By considering or otherwise accounting for changes caused by media processing with the corrected RTCP receiver report, a difference between what was sent from a sender and a receiver's understanding is not the result of media processing, but is rather a valid measure of end-to-end reception quality of an RTP session.

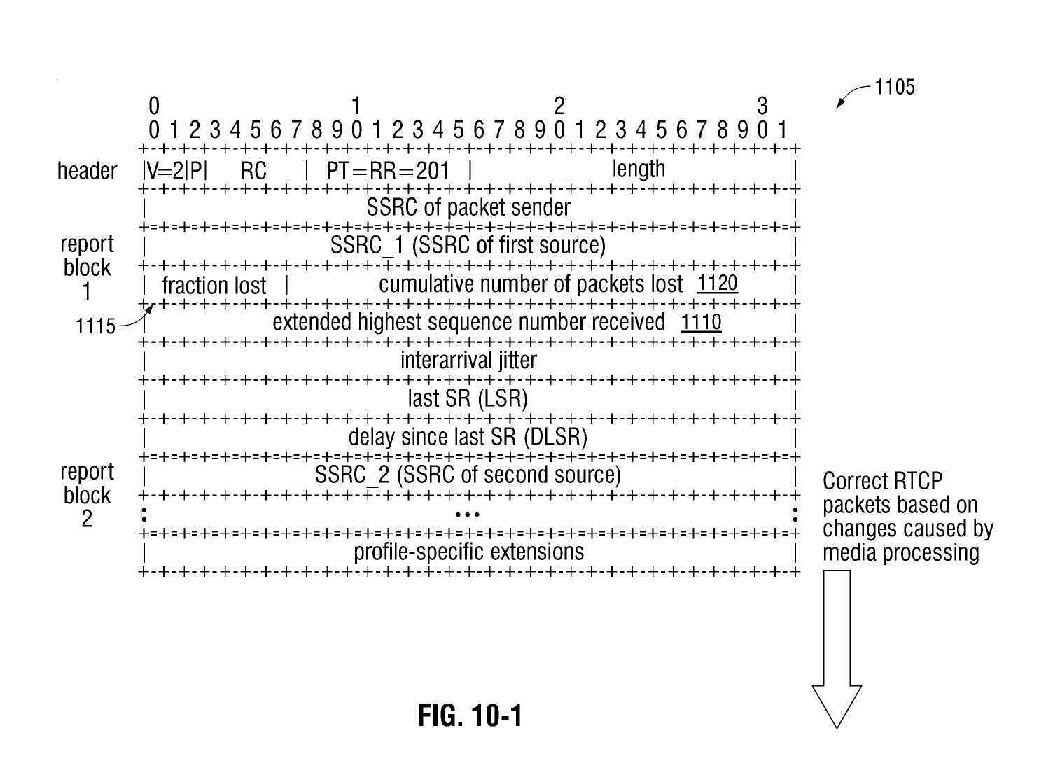

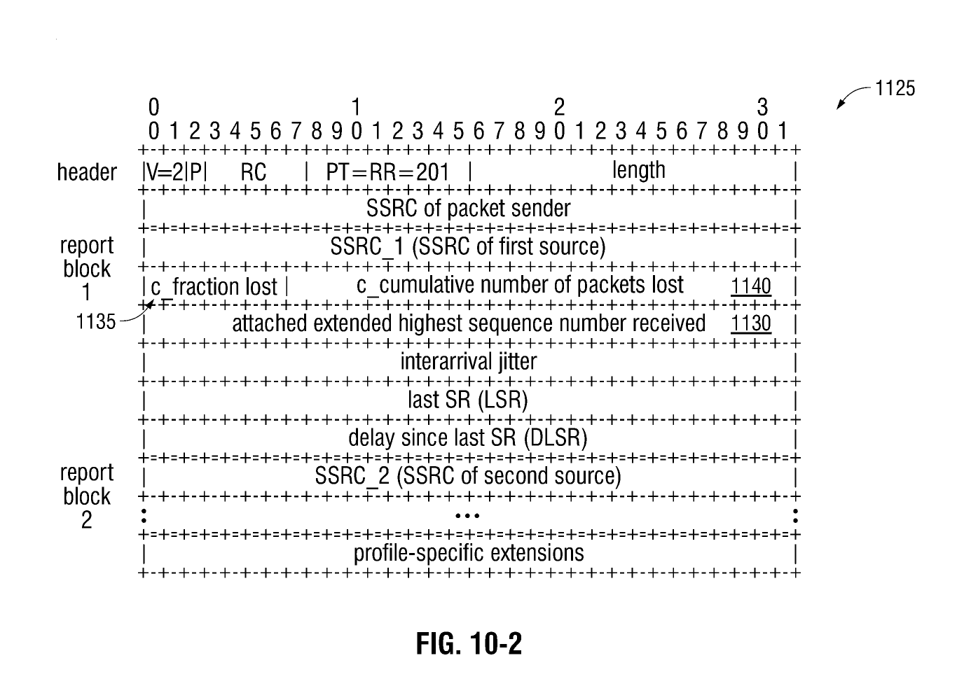

FIG. 10 is a packet diagram that illustrates a receiver report, which may be an RTP control protocol (RTCP) receiver report 1105. In an illustrated example, an embodiment corrects the RTCP receiver report 1105 by replacing an extended highest sequence number received 1110. In a corrected RTCP receiver report 1125, an attached extended highest sequence number received 1130 replaces the extended highest sequence number received 1110. As such, in this embodiment, it may be said that an attached extended highest sequence number received corrects an RTCP receiver report directly.

Other embodiments, on the other hand, correct an RTCP receiver report by replacing a measure of reception quality reported with a measure of reception quality calculated or otherwise determined from an extended highest sequence number received. As such, in these embodiments, it may be said that an attached extended highest sequence number received corrects an RTCP receiver report indirectly.

Continuing with FIG. 10, in the illustrated example, another embodiment replaces a fraction lost 1115 and a cumulative number of packets lost 1120. The fraction lost 1115 is the fraction of RTP data packets from a sender lost since a previous receiver report packet. The cumulative number of packets lost 1120 is the total number of RTP data packets from a sender lost since the beginning of an RTP session.

In the corrected RTCP receiver report 1125, a combined measure of reception quality of RTP packets sent from the sender to the receiver replaces the measure of reception quality of RTP packets sent from the sender. In the illustrated example, a combined fraction lost 1135 (labeled in FIG. 10 as c_fraction lost) and a combined cumulative number of packets lost 1140 (labeled in FIG. 10 as c_cumulative number of packets lost) replace the fraction lost 1115 and the cumulative number of packets lost 1120, respectively.

The embodiment combines a first measure of reception quality of packets sent from a sender with a second measure of reception quality of packets sent to a receiver to produce a combined third measure of reception quality of packets sent from the sender to the receiver.

The combined third measure of reception quality, such as the combined fraction lost 1135 (combined_fraction_lost), may be produced by combining as follows:

combined_fraction_lost=(packet_lost_sender+packet_lost_receiver)/packet_expected (3)

where,

packet_lost_sender is a number of RTP packets sent from the sender lost during a duration defined by a first time and a second time;

packet_lost_receiver is a number of RTP packets sent to the receiver lost during the duration; and

packet_expected is a number of RTP packets expected from the sender during the duration.

In another example, the combined third measure of reception quality, such as the combined cumulative number of packets lost 1140 (combined_cnpl), may be produced by combining as follows:

combined_{—}cnpl=count_{—}cnpl+cnpl_current (4)

where,

count_cnpl is a total number of RTP packets sent from the sender lost during an RTP session (i.e., packet_lost_sender for a duration defined by the RTP session); and

cnpl_current is the total number of RTP packets sent to the receiver lost since the beginning of the RTP session.

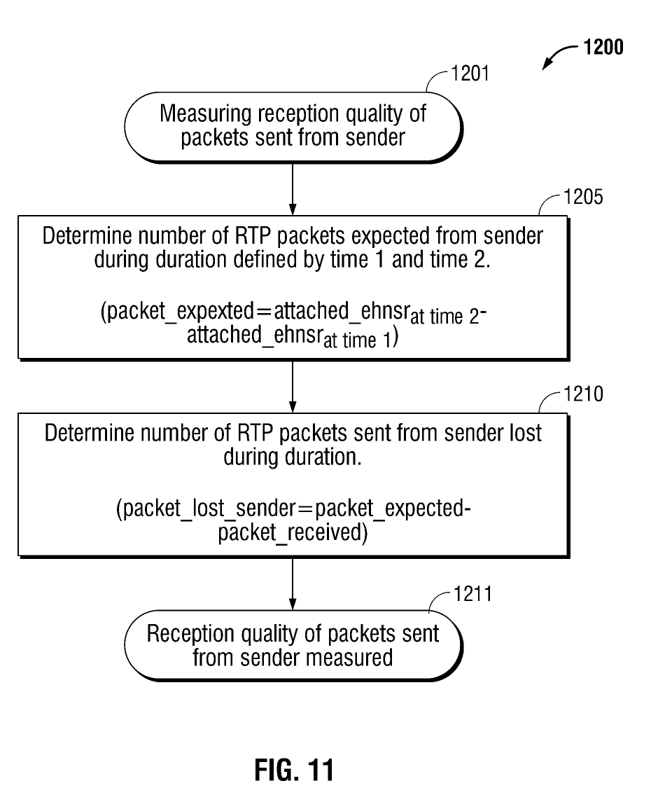

FIG. 11 is a flow chart that illustrates an example process 1200 to measure a reception quality of RTP packets sent from a sender. The process 1200 starts (1201). The process 1200 determines (1205) a number of RTP packets expected from a sender during a duration defined by a first time and a second time (packets_expected). The duration may be a sender report interval which begins with receiving a first sender report and ends with receiving a second sender report. Continuing with FIG. 11, the process 1200 determines (1205) the packets_expected from a first extended highest sequence number received attached to a first RTCP sender report received at the first time (attached_ehsnr_{at time 1}), and (ii) a second extended highest sequence number received attached to a second RTCP sender report received at the second time (attached_ehsnr_{at time 2}), i.e., packets_expected=attached_ehsnr_{at time 2}−attached_ehsnr_{at time 1}.

It is important to note that an RTCP sender report from a sender lacks an appropriate field to report an attached extended highest sequence number received (attached_ehsnr). As noted earlier, an RTP session is typically duplex in which a sender is also a receiver, and vice versa. As such, the RTCP sender report may include one or more report blocks (e.g., the report block 451 of FIG. 3B) reporting what was received by the sender. The extended highest sequence number received (ehsnr) reported in the report block in the RTCP sender report, however, is the extended highest sequence number of a packet received by the sender and not the extended highest sequence number of a packet sent by the sender (i.e., the attached_ehsnr). Accordingly, an attached_ehsnr is not reported in an RTCP sender report from a sender, but is rather attached to the RTCP sender report in the process described above.

The process 1200 determines (1210) a number of RTP packets sent from the sender lost during the duration (packet_lost_sender) from the packets_expected, as determined (1205) above, and a number of RTP packets sent from the sender received prior to media processing during the duration (packets_received), i.e., packet_lost_sender=packet_expected−packet_received.

The process 1200 ends (1211) with the reception quality of the RTP packets sent from the sender measured.

In a convenient embodiment (not shown), in an event an RTCP sender report is received by an RTP immediate system, the embodiment stores (not shown) in an RTCP sender report record the following information: synchronization source (SSRC) of a sender sending the sender report (SSRC_sr), Network Time Protocol (NTP) timestamp of the sender report (NTP_sr), timestamp representing the time when the sender report was received by the RTP immediate system (TS_sr), number of packets expected from the sender during a duration or sender report interval (e.g., the packet_expected determined (1205) above), number of RTP packets sent from the sender lost during the duration (e.g., the packet_lost_sender determined (1210) above).

In another convenient embodiment (not shown), in an event a subject RTCP receiver report is received by an RTP intermediate system to be corrected, the embodiment retrieves a stored number of packets expected from the sender during a duration or sender report interval (e.g., the packet_expected determined (1205) above) and stored number of RTP packets sent from the sender lost during the duration (e.g., the packet_lost_sender determined (1210) above).

To retrieve the foregoing, the embodiment searches RTCP sender report records to find those RTCP sender report records with the same synchronization source (SSRC) as the subject RTCP receiver report, i.e., ssrc_sr=ssrc_rr. In this way, RTCP packets of interest are limited to those packets belonging to the same RTP session or call.

Using the last sender report timestamp in the subject RTCP receiver report (LSR_rr) the embodiment searches the SSRC matching RTCP sender report records to find a subject RTCP sender report record with the same network time protocol (NTP) timestamp (ntp_sr), i.e., ntp_sr=LSR_rr. In this way, the RTCP packets of interest found by the embodiment are further limited to just the subject RTCP packet sender report.

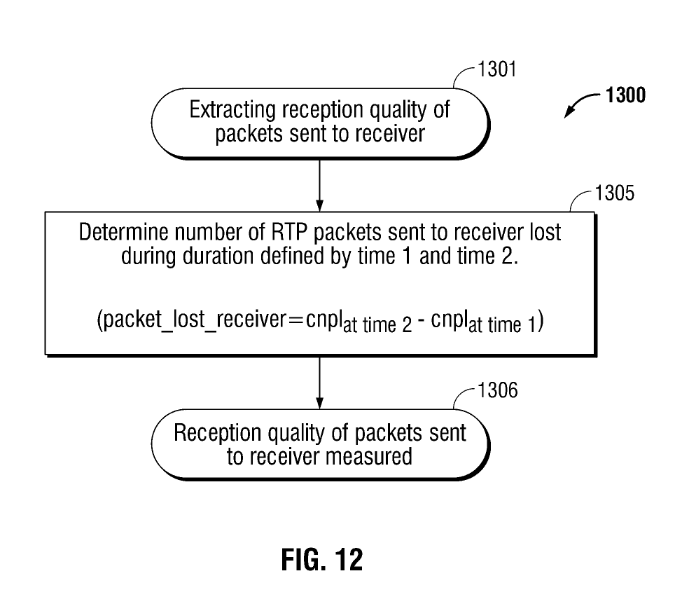

FIG. 12 is a flow chart that illustrates an example process 1300 to extract a reception quality of RTP packets sent to a receiver. The process 1300 starts (1301). The process 1300 determines (1305) a number of RTP packets sent to the receiver lost during a duration defined by a first time and a second time (packets_lost_receiver) from a first cumulative number of packets lost reported in a first RTCP receiver report (such as the RTCP receiver report 1105 of FIG. 10) at the first time (cnpl_{at time 1}), and a second cumulative number of packets lost reported in a second RTCP receiver report at the second time cnpl_{at time 1}, i.e., packet_lost_receiver=cnpl_{at time 2}−cnpl_{at time 1}.

The process 1300 ends (1306) with the reception quality of the RTP packets sent to the receiver extracted.

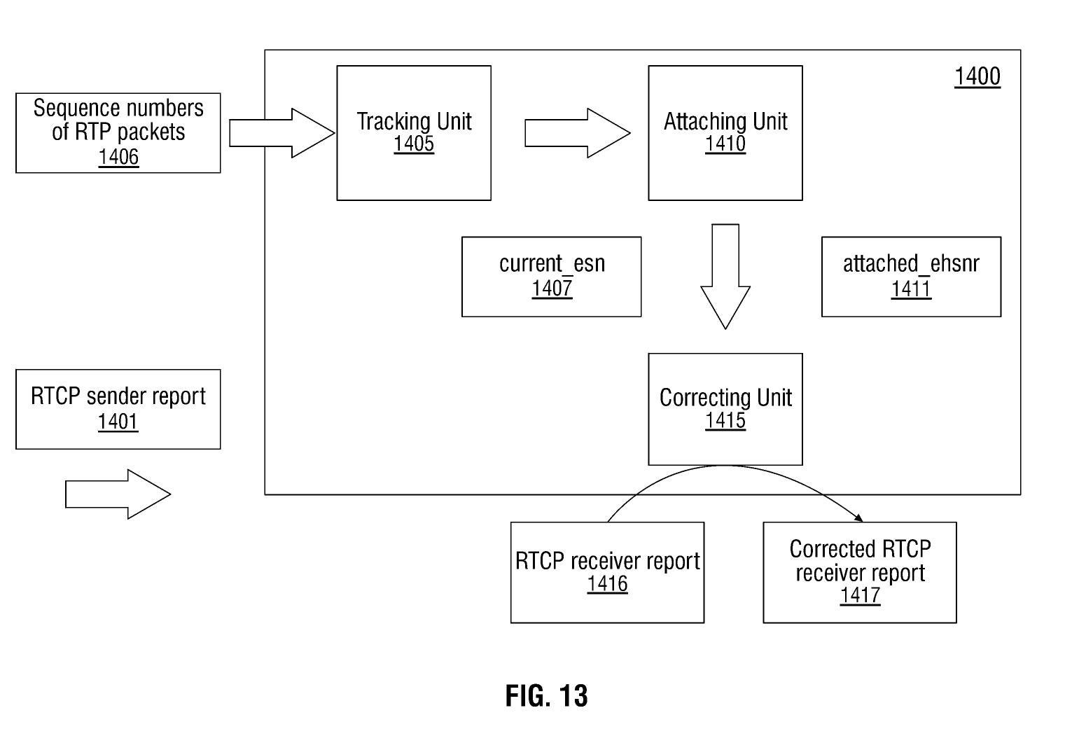

FIG. 13 is a block diagram of an example apparatus 1400 to measure end-to-end reception quality of an RTP session that has a tracking unit 1405, an attaching unit 1410 in communication with the tracking unit 1405, and a correcting unit 1415 in communication with the attaching unit 1410. The tracking unit 1405 tracks sequence numbers of RTP packets sent from a sender 1406 to produce a current extended sequence number 1407. In an event the apparatus 1400 receives an RTCP sender report 1401 (or an indication thereof), the attaching unit 1410 attaches the current extended sequence number 1407 to the received RTCP sender report 1401 to produce an attached extended highest sequence number received 1411. With the attached extended highest sequence number received 1411, the correcting unit 1415 corrects (denoted by an arc with an arrowhead) an RTCP receiver report 1416 resulting in a corrected RTCP receiver report 1417, in accordance with example embodiments described.

While this invention has been particularly shown and described with references to example embodiments thereof, it will be understood by those skilled in the art that various changes in form and details may be made therein without departing from the scope of the invention encompassed by the appended claims.

It should be understood that the network, flow, and block diagrams may include more or fewer elements, be arranged differently, or be represented differently. It should be understood that implementation may dictate the network, flow, and block diagrams and the number of network, flow, and block diagrams illustrating the execution of embodiments of the invention.

It should be understood that elements of the network, flow, and block diagrams described above may be implemented in software, hardware, or firmware. In addition, the elements of the network, flow, and block diagrams described above may be combined or divided in any manner in software, hardware, or firmware. If implemented in software, the software may be written in any language that can support the embodiments disclosed herein. The software may be stored on any form of computer readable medium, such as random access memory (RAM), read only memory (ROM), compact disk read only memory (CD-ROM), and so forth. In operation, a general purpose or application specific processor loads and executes the software in a manner well understood in the art.

TABLE 1

| packet | sn_send (230) | tpcps (235) | tocps (240) |
|---|---|---|---|
| 1st_packet | sn_first | 1 | octet count of packet sent |
| 2nd_packet | sn_send + 1 | tpcps + 1 | tocps + octet count of |
| | | | packet sent |
| 3rd_packet* | sn_send | tpcps | tocps |

*Packet dropped as a result of media processing.

What is claimed is:

1. A method for measuring end-to-end reception quality of a real-time transport protocol (RTP) session, the method comprising:
tracking changes to RTP packets of the RTP session caused by media processing of the RTP packets to produce tracked changes;
modifying RTP packet information of the RTP packets based on the tracked changes;
correcting RTP control protocol (RTCP) packets corresponding to the RTP session based on the tracked changes to produce corrected RTCP packets, the corrected RTCP packets being a measure of the end-to-end reception quality of the RTP session; and
reporting the end-to-end reception quality of the RTP session by forwarding the corrected RTCP packets.

2. The method of claim 1 wherein tracking changes includes:
updating a send sequence number by a number of RTP packets sent to the receiver after media processing;
updating a total packet count of packets sent to the receiver after media processing; and
updating a total octet count of packets sent to the receiver after media processing.

3. The method of claim 2 wherein updating the send sequence number includes:
storing a sequence number of a first RTP packet in the RTP session to be sent after media processing;
setting the send sequence number to the stored sequence number; and
incrementing the send sequence number by one for each RTP packet sent thereafter after media processing.

4. The method of claim 2 wherein updating the total packet count of packets sent includes:
resetting the total packet count of packets sent to one in an event the RTP session is a new RTP session;
incrementing the total packet count of packets by one for each RTP packet sent thereafter after media processing; and
incrementing the total octet count of packets by the octet count of each RTP packet sent thereafter after media processing.

5. The method of claim 1 wherein modifying includes replacing a first sequence number in the RTP packet information of an RTP packet sent from a sender with a second sequence number which is based on the tracked changes.

6. The method of claim 1 wherein correcting includes in an RTCP sender report replacing a first total packet count and octet count of packets sent from a sender with a second total packet count and octet count of packets sent to a receiver which is based on the tracked changes to produce a corrected RTCP sender report, the corrected RTCP sender report being a measure of the end-to-end reception quality of the RTP session.

7. The method of claim 1 further comprising:
tracking sequence numbers of RTP packets sent from a sender to produce a current extended sequence number; and
in an event an RTCP sender report is received, attaching the current extended sequence number to the RTCP sender report to produce an attached extended highest sequence number received at a time of the RTCP sender report received.

8. The method of claim 7 wherein correcting includes in an RTCP receiver report, replacing an extended highest sequence number received with an attached extended highest sequence number received attached to an RTCP sender report which corresponds to the RTCP receiver report to produce a corrected RTCP receiver report, the corrected RTCP receiver report being a measure of the end-to-end reception quality of the RTP session.

9. The method of claim 8 further comprising:
in an event an RTCP sender report is received, storing in an RTCP sender report record: (i) a synchronization source identifying a source of the RTCP sender report (ssrc_sr), (ii) an NTP timestamp of the RTCP sender report (ntp_sr) representing when the RTCP sender report was sent, and (iii) the attached extended highest sequence number received attached to the RTCP sender report received; and
in an event an RTCP receiver report is received, retrieving from a corresponding RTCP sender report record, a stored attached extended highest sequence number received attached to a corresponding RTCP sender report which corresponds to the RTCP receiver report received, the corresponding RTCP sender report record having: (i) a stored synchronization source the same as a reported synchronization source reported in the RTCP receiver report received (ssrc_rr); and (ii) a stored NTP timestamp the same as a reported last SR timestamp reported in the RTCP receiver report received (lsr_rr) representing when the last RTCP sender report was received.

10. The method of claim 7 wherein correcting includes:
measuring a reception quality of RTP packets sent from the sender to produce a measured first measure of reception quality of RTP packets sent from the sender;
extracting from an RTCP receiver report a reception quality of RTP packets sent to a receiver to produce an extracted second measure of reception quality of RTP packets sent to the receiver;
combining the measured first measure of reception quality with the extracted second measure of reception quality to produce a combined third measure of reception quality of RTP packets sent from the sender to the receiver;
replacing in the RTCP receiver report, a measure of reception quality of RTP packets sent to the receiver with the combined third measure of reception quality of RTP packets sent from the sender to the receiver to produce a corrected RTCP receiver report, the corrected RTCP receiver report being a measure of the end-to-end reception quality of the RTP session.

11. The method of claim 10 wherein measuring includes determining: (a) a number of RTP packets expected from the sender during a duration defined by a first time and a second time and (b) a number of RTP packets sent from the sender lost during the duration from: (i) a first attached extended highest sequence number attached to a first RTCP sender report received at the first time, (ii) a second attached extended highest sequence number attached to a second RTCP sender report received at the second time, and (iii) a number of RTP packets sent from the sender received prior to media processing during the duration, to produce the measured first measure of reception quality.

12. The method of claim 11 further comprising:
in an event an RTCP sender report is received, storing in an RTCP sender report record: (i) a synchronization source identifying a source of the RTCP sender report (ssrc_sr), (ii) an NTP timestamp of the RTCP sender report (ntp_sr) representing when the RTCP sender report was sent, (iii) the number of RTP packets expected during the duration, and (iv) a number of RTP packets sent from the sender lost during the duration; and
in an event an RTCP receiver report is received, retrieving from a corresponding RTCP sender report record: (a) a stored number of RTP packets expected during a duration, and (b) a stored number of RTP packets sent from the sender lost during the duration, the corresponding RTCP sender report record having: (i) a stored synchronization source the same as a reported synchronization source reported in the RTCP receiver report received (ssrc_rr); and (ii) a stored NTP timestamp the same as a reported last SR timestamp reported in the RTCP receiver report received (lsr_rr) representing when the last RTCP sender report was received.

13. The method of claim 10 wherein extracting includes determining a number of RTP packets sent to the receiver lost during a duration defined by a first time and a second time from: (i) a first cumulative number of packets lost reported in a first RTCP receiver report at the first time and (ii) a second cumulative number of packets lost reported in a second RTCP receiver report at the second time, to produce the extracted second measure of reception quality.

14. An apparatus to measure end-to-end reception quality of a real-time transport protocol (RTP) session, comprising:
a tracking unit to track changes to RTP packets of the RTP session caused by media processing of the RTP packets to produce tracked changes;
a modifying unit in communication with the tracking unit to modify RTP packet information of the RTP packets based on the tracked changes;
a correcting unit in communication with the tracking unit to correct RTP control protocol (RTCP) packets corresponding to the RTP session based on the tracked changes to produce corrected RTCP packets, the corrected RTCP packets being a measure of the end-to-end reception quality of the RTP session; and
a reporting unit to report the end-to-end reception quality of the RTP session by forwarding the corrected RTCP packets.

15. The apparatus of claim 14 wherein the tracking unit includes:
a first updating unit to update a send sequence number by a number of RTP packets sent to the receiver after media processing;
a second updating unit to update a total packet count of packets sent to the receiver after media processing; and
a third updating unit to update a total octet count of packets sent to the receiver after media processing.

16. The apparatus of claim 15 wherein the first updating unit includes:
a storing unit to store a sequence number of a first RTP packet in the RTP session to be sent after media processing;
a setting unit to set the send sequence number to the stored sequence number; and
a incrementing unit to increment the send sequence number by one for each RTP packet sent thereafter after media processing.

17. The apparatus of claim 15 wherein the second updating unit includes:
a resetting unit to reset the total packet count of packets sent to one in an event the RTP session is a new RTP session;
a first incrementing unit to increment the total packet count of packets by one for each RTP packet sent thereafter after media processing; and
a second incrementing unit to increment the total octet count of packets by the octet count of each RTP packet sent thereafter after media processing.

18. The apparatus of claim 14 wherein modifying unit includes a replacing unit to replace a first sequence number in the RTP packet information of an RTP packet sent from a sender with a second sequence number which is based on the tracked changes.

19. The apparatus of claim 14 wherein the correcting unit includes a replacing unit to replace, in an RTCP sender report, a first total packet count and octet count of packets sent from a sender with a second total packet count and octet count of packets sent to a receiver which is based on the tracked changes to produce a corrected RTCP sender report, the corrected RTCP sender report being a measure of the end-to-end reception quality of the RTP session.

20. The apparatus of claim 14 further comprising:
a tracking unit to track sequence numbers of RTP packets sent from a sender to produce a current extended sequence number; and
an attaching unit in communication with the tracking unit and the correcting unit to attach, in an event an RTCP sender report is received, the current extended sequence number to the RTCP sender report to produce an attached extended highest sequence number received at a time of the RTCP sender report received.

21. The apparatus of claim 20 wherein the correcting unit includes a replacing unit to replace, in an RTCP receiver report, an extended highest sequence number received with an attached extended highest sequence number received attached to an RTCP sender report which corresponds to an RTCP receiver report to produce a corrected RTCP receiver report, the corrected RTCP receiver report being a measure of the end-to-end reception quality of the RTP session.

22. The apparatus of claim 21 further comprising:
a storing unit to store, in an event an RTCP sender report is received, in an RTCP sender report record: (i) a synchronization source identifying a source of the RTCP sender report (ssrc_sr), (ii) an NTP timestamp of the RTCP sender report (ntp_sr) representing when the RTCP sender report was sent, and (iii) the attached extended highest sequence number received attached to the RTCP sender report received; and
a retrieving unit to retrieve, in an event an RTCP receiver report is received, from a corresponding RTCP sender report record a stored attached extended highest sequence number received attached to a corresponding RTCP sender report which corresponds to the RTCP receiver report received, the corresponding RTCP sender report record having: (i) a stored synchronization source the same as a reported synchronization source reported in the RTCP receiver report received (ssrc_rr); and (ii) a stored NTP timestamp the same as a reported last SR timestamp reported in the RTCP receiver report received (lsr_rr) representing when the last RTCP sender report was received.

23. The apparatus of claim 20 wherein the correcting unit includes:
a measuring unit to measure a reception quality of RTP packets sent from the sender to produce a measured first measure of reception quality of RTP packets sent from the sender;
an extracting unit to extract from an RTCP receiver report a reception quality of RTP packets sent to a receiver to produce an extracted second measure of reception quality of RTP packets sent to the receiver;
a combining unit to combine the measured first measure of reception quality with the extracted second measure of reception quality to produce a combined third measure of reception quality of RTP packets sent from the sender to the receiver;
a replacing unit to replace, in the RTCP receiver report, a measure of reception quality of RTP packets sent to the receiver with the combined third measure of reception quality of RTP packets sent from the sender to the receiver to produce a corrected RTCP receiver report, the corrected RTCP receiver report being a measure of the end-to-end reception quality of the RTP session.

24. The apparatus of claim 23 wherein the measuring unit includes a determining unit to determine: (a) a number of RTP packets expected from the sender during a duration defined by a first time and a second time and (b) a number of RTP packets sent from the sender lost during the duration from: (i) a first attached extended highest sequence number attached to a first RTCP sender report received at the first time, (ii) a second attached extended highest sequence number attached to a second RTCP sender report received at the second time, and (iii) a number of RTP packets sent from the sender received prior to media processing during the duration, to produce the measured first measure of reception quality.

25. The apparatus of claim 24 further comprising:
a storing unit to store, in an event an RTCP sender report is received, in an RTCP sender report record: (i) a synchronization source identifying a source of the RTCP sender report (ssrc_sr), (ii) an NTP timestamp of the RTCP sender report (ntp_sr) representing when the RTCP sender report was sent, (iii) the number of RTP packets expected during the duration, and (iv) a number of RTP packets sent from the sender lost during the duration; and
a retrieving unit to retrieve, in an event an RTCP receiver report is received, from a corresponding RTCP sender report record: (a) a stored number of RTP packets expected during a duration, and (b) a stored number of RTP packets sent from the sender lost during the duration, the corresponding RTCP sender report record having: (i) a stored synchronization source the same as a reported synchronization source reported in the RTCP receiver report received (ssrc_rr); and (ii) a stored NTP timestamp the same as a reported last SR timestamp reported in the RTCP receiver report received (lsr_rr) representing when the last RTCP sender report was received.

26. The apparatus of claim 23 wherein the extracting unit includes a determining unit to determine a number of RTP packets sent to the receiver lost during a duration defined by a first time and a second time from: (i) a first cumulative number of packets lost reported in a first RTCP receiver report at the first time and (ii) a second cumulative number of packets lost reported in a second RTCP receiver report at the second time, to produce the extracted second measure of reception quality.

27. A computer program product including a computer readable medium having a computer readable program, the computer readable program, when executed by a computer causes the computer to:
track changes to real-time transport protocol (RTP) packets of an RTP session caused by media processing of the RTP packets to produce tracked changes;
modify RTP packet information of the RTP packets based on the tracked changes;
correct RTP control protocol (RTCP) packets corresponding to the RTP session based on the tracked changes to produce corrected RTCP packets, the corrected RTCP packets being a measure of the end-to-end reception quality of the RTP session; and
report the end-to-end reception quality of the RTP session by forwarding the corrected RTCP packets.
